(19) United States
(12) Patent Application Publication
(10) Pub. No.: US 2013/0003600 A1
(43) Pub. Date: Jan. 3, 2013

(54) Configuration of Interfaces Communicatively Coupled to Link-Local Zones in a Network

(75) Inventor: Seth D. Jennings, Austin, TX (US)

(73) Assignee: International Business Machines Corporation, Armonk, NY (US)

(21) Appl. No.: 13/171,984

(22) Filed: Jun. 29, 2011

(51) Int. Cl. H04L 12/28

(52) U.S. Cl. 370/254

(57) ABSTRACT

Some example embodiments include a method for configuring of a node on a network. The method includes configuring an interface of the node on the network. The configuring includes performing duplicate address detection for an address to be assigned to the interface as part of the configuring. The duplicate address detection comprises transmitting, out from the interface onto the network, an address detection message having a destination address that is the same as the address to be assigned to the interface. The configuring also includes responsive to receiving the address detection message on a different interface of the node, determining that the interface and the different interface are on a same link of the network and assigning the interface to be in a same link-local zone as the different interface.

### BACKGROUND

Embodiments of the inventive subject matter generally relate to the field of networking, and, more particularly, to configuration of interfaces communicatively coupled to link-local zones in a network.

Networks can include a number of different network topologies and based on different communication protocols. Some networks are configured such that addressing in a subset of a network topology is unique for that subset. An example protocol for communication for this type of addressing in subset of a network topology includes Internet Protocol, version 6 (IPv6) (See Request For Comments (RFC) 2460, December, 1998).

### SUMMARY

Some example embodiments include a method for configuring of a node on a network. The method includes configuring an interface of the node on the network. The configuring includes performing duplicate address detection for an address to be assigned to the interface as part of the configuring. The duplicate address detection comprises transmitting, out from the interface onto the network, an address detection message having a destination address that is the same as the address to be assigned to the interface. The configuring also includes responsive to receiving the address detection message on a different interface of the node, determining that the interface and the different interface are on a same link of the network and assigning the interface to be in a same link-local zone as the different interface.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a network having multiple link-local zones, according to some example embodiments.

FIG. 2 depicts a node in a network having multiple link-local zones, according to some example embodiments.

FIGS. 3-4 depict flowcharts for configuring of multiple interfaces for a node a network having multiple link-local zones, according to some example embodiments.

FIG. 5 depicts a network configuration having multiple networks with link-local zones, according to some example embodiments.

FIG. 6 depicts a computer system, according to some example embodiments.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to use of the IPv6 protocol, any other type of protocol can be used that allows for link-local addressing (as described herein). In other instances, well-known instruction instances, protocols, structures and techniques have not been shown in detail in order not to obfuscate the description.

Some example embodiments resolve route ambiguity for routing of outgoing packets from a node (e.g., a router, server, client device, etc.). Some example embodiments provide for routing in a network having addressing based on a scoped address architecture. An example protocol used in a scoped address architecture includes Internet Protocol (version 6). In such an architecture, the addresses therein are only usable over a subset of a network topology (e.g., Local Area Network (LAN)). A “scoped address” is an address that is only guaranteed to be unique over a certain topological area of the network. For example, a link-local address is only guaranteed to be unique on the link to which a particular interface is communicatively coupled. A zone is an instance of a scope relative to the scoped address architecture. For example, if a node has two interfaces and the two interfaces are communicatively coupled to different links, then that node is communicatively coupled to two link-local zones. Conversely, if the two interfaces of the node are communicatively coupled to a same link, then the node is only communicatively coupled to one link-local zone (reachable from either interface).

In a scoped address architecture, for a given node that has multiple interfaces, the multiple interfaces have a same link-local prefix. Such a situation can affect routing of data out from the node because route ambiguity can be introduced if the multiple interfaces are communicatively coupled to different zones. In particular, the node cannot determine which interface to output the data from because the node is not certain to which zone the destination node is attached. The destination node could be located in any of the connected zones.

Some example embodiments detect when two interfaces on a same node are communicatively coupled to a same link within a scoped address architecture. The node can then configure these two interfaces in a same link-local zone.

during configuration of an interface, an interface can become a member of 16 zones—one at each scope level. The address scopes are defined in RFC 4291, February 2006 and are as follows:

0—Reserved

1—Interface-Local Scope

2—Link-Local Scope

3—Reserved

4—Admin-Local Scope

5—Site-Local Scope

6—Unassigned

7—Unassigned

8—Organization-Local Scope

9—Unassigned

A—Unassigned

B—Unassigned

C—Unassigned

D—Unassigned

E—Global Scope

For scopes less than the third address scope (Link-Local Scope), interfaces can be automatically put into a zone of their own (because, by definition, the Interface-Local Scope is a scope that contains only the interface and no links). For scopes that are greater than the third address scope (Link-Local Scope), the interface can be put into a default zone for that scope. However, for the link-local scope, a different approach is needed. Some example embodiments provide a different approach (as described herein).

During interface configuration, the interface is placed into a link-local zone. However, the link topology is not known by the node having the interface. In particular, the node having the interface does not know whether another of its interfaces is communicatively coupled to the same link. In such a situation, the node would configure the interface to be in the same link-local zone. Some conventional systems put each interface in their own link-local zone. Such a method assumes that each interface is communicatively coupled to a different topological link. However, there are many configurations in which a node can have multiple interfaces communicatively coupled to a same link. In this situation, the zone configuration on the node is incorrect. Other conventional systems put all interfaces in a same link-local zone. Such a method assumes that each interface is communicatively coupled to a same topological link. In this situation, the node views all the interfaces as being on the same link. This configuration is equivalent to not having zones, thereby reintroducing route ambiguity (until a user manually configures the zones properly). Using the methods of these conventional systems can cause an incorrect link-local zone configuration.

Some example can leverage neighbor detection operations to properly configure multiple interfaces on a same node in a scoped address architecture. In particular when an address is configured for an interface of a node, duplicate address detection is performed. The duplicate address detection verifies that the address to be used for an interface is not already configured somewhere on the link (being used by a different interface). This duplicate address detection comprises transmitting neighbor solicitations messages from the interface being configured with the address that is to be assigned to this interface. If a different interface responds to the neighbor solicitations messages with a neighbor advertisement message, then another node on the network already has the address configured (thus this address cannot be used for this interface).

Some example embodiments use the messaging for duplicate address detection to properly configure multiple interfaces on a same node in a scoped address architecture. In some example embodiments, if a neighbor solicitation message is received from a first interface by a second interface of the same node, then the first interface and the second interface are on a same link and can be configured to be in a same zone. Accordingly, existing duplicate address detection operations used in a scoped address architecture can be used to also properly configure the interface with the correct link. Therefore, the network address and proper zone identifier for an interface for a node can be configured using the messaging for duplicate address detection.

In some example embodiments, the node is a router with multiple interfaces to different links. In some example embodiments, the node can be a server with multiple interfaces. A first interface for the server is publicly addressable on a public network for public access of the server. A second interface for the server can be only privately addressable on a private network and can be used for control and management information.

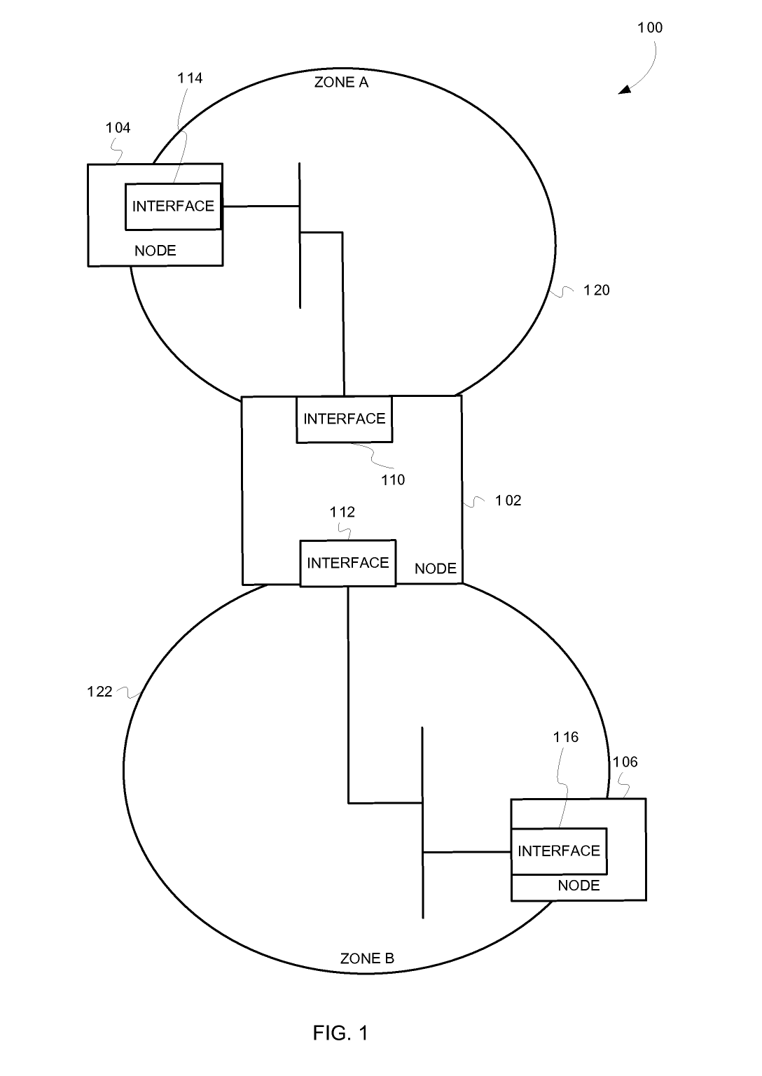

FIG. 1 depicts a network having multiple link-local zones, according to some example embodiments. In particular, FIG. 1 depicts a network 100 that includes three different nodes—a node 102, a node 104, and a node 106. In some example embodiments, the network 100 can be any type of network having a scoped address architecture (e.g., Local Area Network (LAN)). For a scoped address architecture, the network addresses therein are only usable over the network 100. In other words, the network addresses used therein are not global addresses that have meaning for network transmission outside the network 100. The node 102, the node 104, and the node 106 can be any type of device that can communicate over a network (e.g., a router, server, client device, etc.). The network 100 includes two link-local zones—a zone A 120 and a zone B 122.

The nodes 102-106 include one or more interfaces for network communications with other nodes in the network 100. The interfaces can include any type of network interface controller, network interface card, network adapter, etc. that provides for network communications with other nodes in the network 100. In some example embodiments, the network communications is based on IPv6 network protocol. The node 102 includes two interfaces—an interface 110 and an interface 112. The node 104 includes an interface 114. The node 106 includes an interface 116. In this example, the two interfaces for the node 102 are communicatively coupled to two different link-local zones. The interface 110 is communicatively coupled to the zone A 120, and the interface 112 is communicatively coupled to the zone B 122. The interface 114 of the node 104 is communicatively coupled to the zone A 120. The interface 116 is communicatively coupled to the zone B 122.

In some example embodiments, an address is only unique for the link-local zone. Accordingly, if a node has two different interfaces on two different link-local zones, route ambiguity can occur. In particular, assume that the interface 114 of the node 104 and the interfaces 116 of the node 106 have a same address (which allowable because the two interfaces are communicatively coupled to two different link-local zones). In such a situation, route ambiguity can occur in the node 102 unless the zones to which its interfaces are coupled are known (because a same address can be used for the interface 114 of the node 104 and the interface 116 of the node 106).

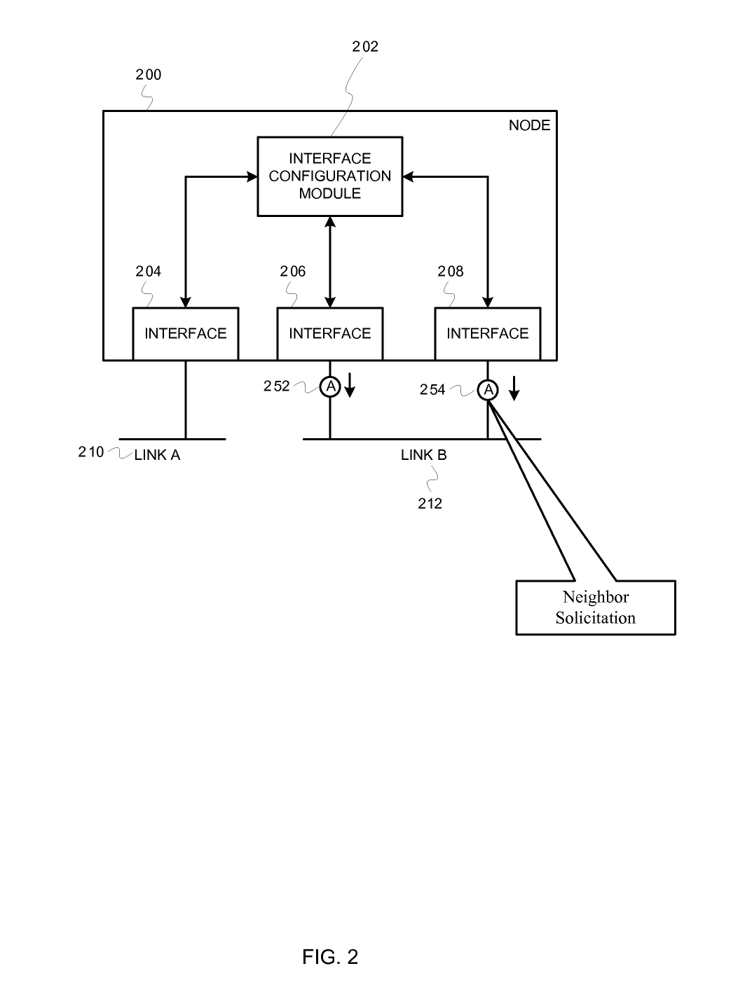

Some example can leverage neighbor detection operations to properly configure multiple interfaces on a same node in a scoped address architecture. To illustrate, FIG. 2 depicts a node in a network having multiple link-local zones, according to some example embodiments. A node 200 includes three interfaces on two different link-local zones. An interface 204 is communicatively coupled to a link-local zone 210 (link A). An interface 206 and an interface 208 are communicatively coupled to a link-local zone 212 (link B). The node 202 also includes an interface configuration module 202 that is communicatively coupled to the interface 204, the interface 206, and the interface 208.

The interface configuration module 202 can be software, firmware, hardware or a combination thereof. For example, the interface configuration module 202 can be software that is loaded into a processor for execution therein. The interface configuration module 202 configures each of the interfaces 204-208. The configuration can include assignment of a network address and assignment to a correct link-local zone. In some example embodiments, the interface configuration module 202 leverages the operations for assigning a network address to assign a correct link-local zone for an interface.

During configuration for assigning a network address for an interface, each interface performs duplicate address detection to verify that the address to be used for the interface is not already configured somewhere on the link (being used by a different interface). This duplicate address detection comprises transmitting neighbor solicitations messages from the interface being configured with the address that is to be assigned to this interface. If a different interface responds to the neighbor solicitations messages with a neighbor advertisement message, then another node on the network already has the address configured (thus this address cannot be used for this interface).

Assume that the interfaces are not yet operational and are to be configured. The interface 204 is configured first. In this situation, the interface configuration module 202 determines that there are not other interfaces with link-local address on the node 200. Accordingly, the interface configuration module 202 configures the interface 204 in a first link-local zone—the link-local zone 210.

The interface 206 is configured next. The interface configuration module 202 determines that another interface having a link-local address is configured for the node 200—the interface 204. In this situation, zone detection is executed as part of the duplicate address detection. In particular, the interface 206 transmits a neighbor solicitation message 252 (denoted by point A) to the interface 204 onto the network in the link-local zone 212. In this case, the interface 204 is not part of the link-local zone 212 and therefore would not receive the neighbor solicitation message 252. Also, the interface 208 would not receive because it is still not configured. After a timeout, the interface configuration module 202 determines that the interface 204 and the interface 206 are not communicatively coupled to a same link-local zone. Accordingly, the interface configuration module 202 configures the interface 206 in a second link-local zone—the link-local zone 212.

The interface 208 is configured next. The interface configuration module 202 determines that two other interfaces having a link-local address are configured for the node 200—the interface 204 and the interface 206. In this situation, zone detection is executed as part of the duplicate address detection. In particular, the interface 208 transmits a neighbor solicitation message 254 (denoted by point A) to the interface 204 and the interface 206 onto the network in the link-local zone 212. In this case, the interface 204 is not part of the link-local zone 212 and therefore would not receive the neighbor solicitation message 254. However, the interface 206 would receive the neighbor solicitation message 252 because the interface 206 and the interface 208 are part of the same link-local zone—the link-local zone 212. Based on the receipt of the neighbor solicitation message 252 at the interface 206, the interface configuration module 202 determines that the interface 206 and the interface 208 are on the same link-local zone—the link-local zone 212. Accordingly, the interface configuration module 202 assigns the interface 208 with the link-local zone 212. The node 200 is now properly configured with the correct link topology. Such configuration of the correctly topology is performed using at least some of the operations for duplicate address detection of the interfaces—use of the neighbor solicitations messages. Therefore, separate messaging among the interfaces is not required to properly configure the correct link topology for the interfaces.

Operations associated with some example embodiments are now described. In the discussion below, the flowcharts will be described with reference to the block diagrams presented above. However, in some example embodiments, the operations can be performed by logic not described in the block diagrams. In certain embodiments, the operations can be performed by executing instructions residing on machine-readable media (e.g., software), while in other embodiments, the operations can be performed by hardware and/or other logic (e.g., firmware). In some example embodiments, the operations can be performed in series, while in other embodiments, one or more of the operations can be performed in parallel. Moreover, some embodiments can perform less than all the operations shown in any flowchart.

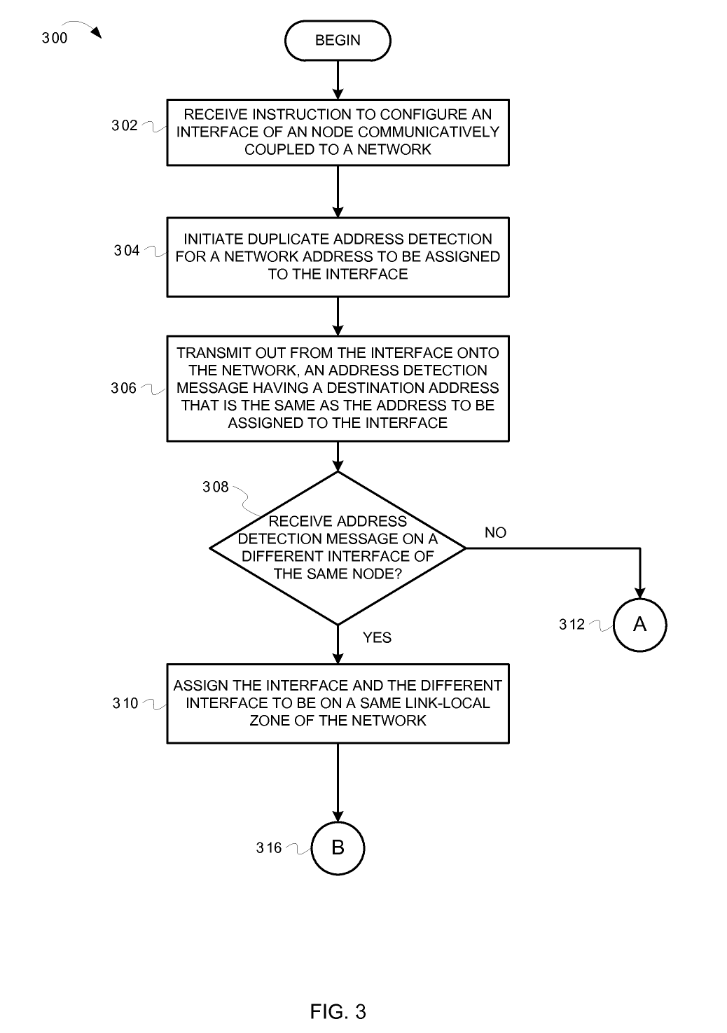

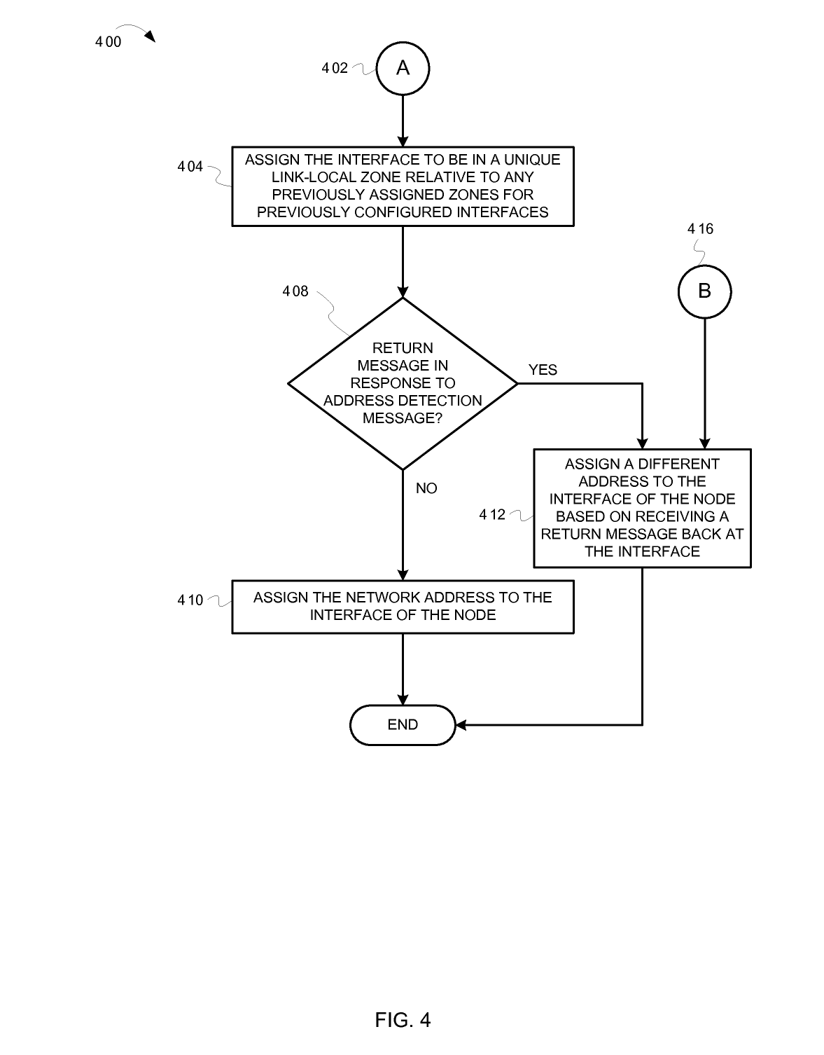

FIGS. 3-4 depict flowcharts for configuring of multiple interfaces for a node a network having multiple link-local zones, according to some example embodiments. FIG. 3 depicts a flowchart 300, and FIG. 4 depicts a flowchart 400. Operations of the flowchart 300 continue with operations of the flowchart 400 at transitions points A and B (as further described below). The operations of flowcharts 300 and 400 are described in reference to FIGS. 1-2. The operations of the flowchart 300 begin at block 302.

At block 302, the interface configuration module 202 receives an instruction to configure an interface of a node communicatively coupled to a network. For example, the interface configuration module 202 can receive this instruction during an initial power on of the node, after reset of the node, after an interface is activated or reset, etc. Operations of the flowchart 300 continue at block 304.

At block 304, the interface configuration module 202 initiates duplicate address detection for a network address to be assigned to the interface. In particular, the interface configuration module 202 performs this operation to assign a network address to the interface that is not currently assigned to another node that is communicatively coupled to the same link-local zone. Operations of the flowchart 300 continue at block 306.

At block 306, the interface configuration module 202 transmits out from the interface onto the network, an address detection message having a destination address that is the same as the address to be assigned to the interface. With reference to FIG. 2, the interface configuration module 202 causes the interface 206 and the interface 208 to transmit a neighbor solicitation message to having a destination address that is the same as the address that the interface configuration module 202 is considering assigning to the interface. Operations of the flowchart 300 continue at block 308.

At block 308, the interface configuration module 202 determines whether the address detection message is received on a different interface of the same node. For example with reference to FIG. 2 (as part of the configuration of the interface 208), the interface configuration module 202 determines whether the neighbor solicitation message 254 transmitted out from the interface 208 is received by the interface 206 or the interface 204. If the address detection message is not received on a different interface of the same node, operations of the flowchart 300 continue at a transition point A 312, which continues at a transition point A 402 of the flowchart 400 of FIG. 4. Otherwise, if the address detection message is received on a different interface of the same node, operations of the flowchart 300 continue at block 310.

At block 310, the interface configuration module 202 assigns the interface and the different interface to be on a same link of the network. Continuing with the example above with reference to FIG. 2, the interface 206 receives the neighbor solicitation message 254 because the interface 208 and the interface 208 are on the same link-local zone (the link-local zone 212). In response, the interface configuration module 202 assigns the interface 208 to be on the same link (link-local zone) as the interface 206 (which received the neighbor solicitation message 254). Accordingly, some example embodiments use the address detection operations (neighbor solicitation messages) to assign link-local zones to an interface. Operations of the flowchart 300 continue at block 314. Operations of the flowchart 300 continue at a transition point B 316, which continues at a transition point B 416 of the flowchart 400 of FIG. 4.

FIG. 4 is now described. The operations of the flowchart 400 begin at the transition point A 402, which is from the transition point A 312 of the flowchart 300 of FIG. 3. From the transition point A 402, operations continue at block 404.

At block 404, the interface configuration module 202 assigns the interface to be in a unique link-local zone relative to any previously assigned zones for previously configured interfaces. Continuing with the example above with reference to FIG. 2, assume that the interface 206 is not part of the node 200 or is not on the same link-local zone 212 as the interface 208. In this case, after the interface 208 transmits the neighbor solicitation message 254, no other interface would receive this message. Accordingly, the interface configuration module 202 would assign the interface 208 to a unique link-local zone that was not previously assigned to another interface of the node 200. Operations of the flowchart 400 continue at block 408.

Operations at blocks 408-412 completes the assignment of the network address to the interface based on this neighbor solicitation messaging.

At block 408, the interface configuration module 202 determines whether a return message is received in response to the address detection message. For example with reference to FIG. 2, assume that a different interface of a different node (not shown) that is communicatively coupled to the link-local zone 212 has been assigned a network address based on its configuration and assume that the interface configuration module 202 is attempting to assign the same network address to the interface 208. The interface 208 would transmit the neighbor solicitation message 254 having a destination address for this different interface of a different node out on the link-local zone 212. The different interface of the different node would respond with a return message (a neighbor advertisement message) that is transmitted back to the interface 208. If a return message is not received in response to the address detection message, operations of the flowchart 400 continue at block 410. Otherwise, operations of the flowchart 400 continue at block 412.

At block 410, the interface configuration module 202 assigns the network address to the interface of the node. Continuing with the example above at block 408, the interface configuration module 202 would assign the network address to the interface 208 (that the interface configuration module 202 was attempting to assign to the interface 208), because no other interface on the link-local zone has been assigned this network address. Operations of the flowchart 400 are complete.

At block 412, the interface configuration module 202 assigns a different address to the interface of the node based on receiving a return message back at the interface. Continuing with the example above at blocks 408-410, the interface configuration module 202 would assign a new network address to the interface 208 (not the network address that the interface configuration module 202 was attempting to assign to the interface 208), because a different interface on the link-local zone has been assigned this network address. Operations of the flowchart 400 are complete.

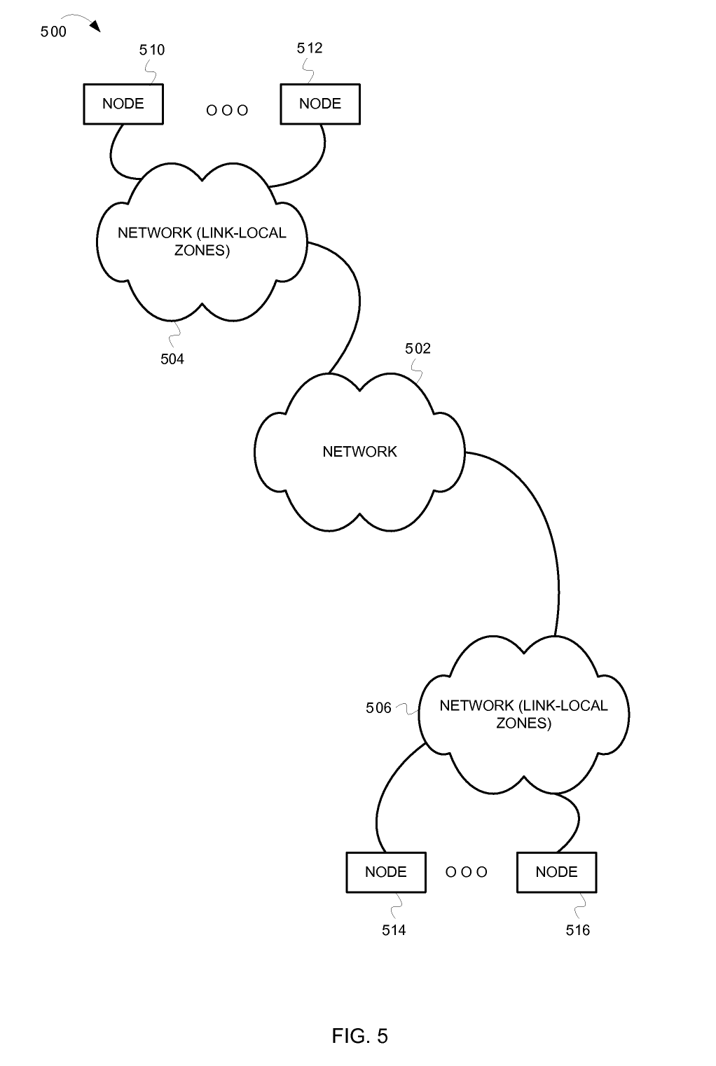

FIG. 5 depicts a network configuration having multiple networks with link-local zones, according to some example embodiments. In particular, Figure depicts a network 500 having a number of networks communicatively coupled together. The network 500 includes a network 502, a network 504, and a network 506. In this example, the network 504 and the network 506 have link-local zones (as described herein). For example, the network 504 and the network 506 can be LANs. Multiple nodes (as described above) are communicatively coupled to the network 504 (shown as a node 510 and a node 512). Similarly, multiple nodes (as described above) are communicatively coupled to the network 506 (shown as a node 514 and a node 516). The networks 504 and 506 can be based on a scoped address architecture, wherein their link-local addressing only has meaning within their network. The network 502 can be any type of network for providing network communications (e.g., Wide Area Network, LAN, etc.). In this example, the network 502 is not based on a scoped address architecture. Accordingly when the nodes (the nodes 510-516) are attempting to communicating outside their network, a new global network address is needed for the messaging to have meaning for network communications outside their network—the link-local addressing would insufficient.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

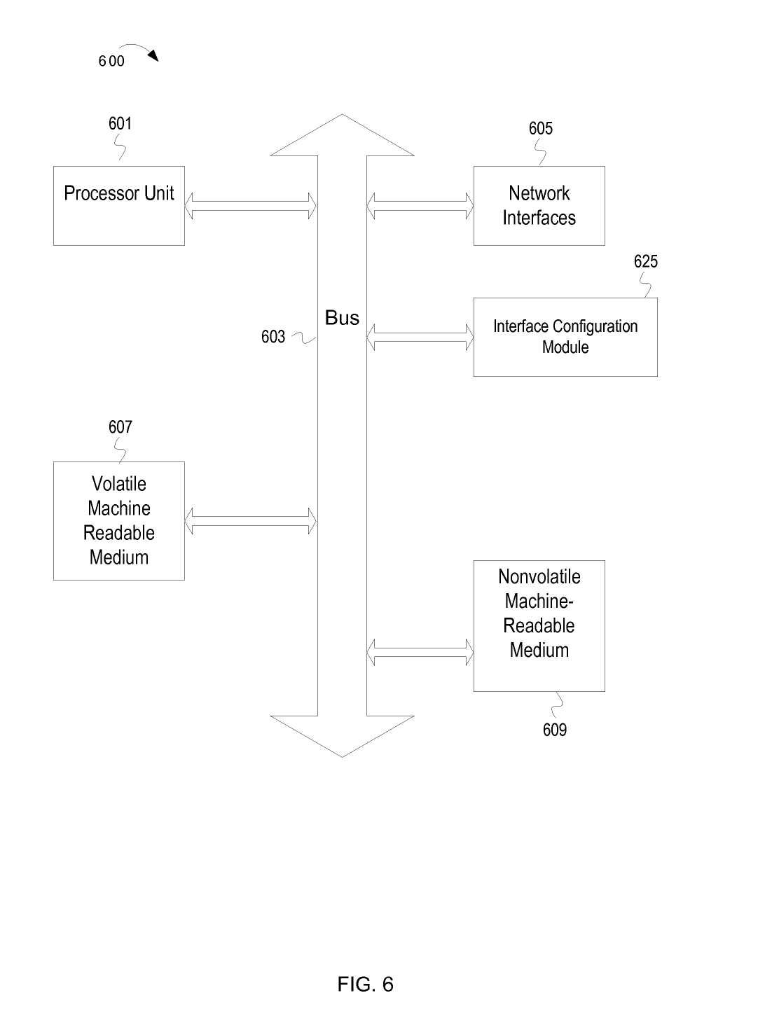

FIG. 6 depicts a computer system, according to some example embodiments. In particular, a computer system 600 can be representative of a node that is coupled to one or more link-local zones (as described herein). The computer system 600 includes a processor unit 601 (possibly including multiple processors, multiple cores, multiple nodes, and/or implementing multi-threading, etc.). The computer system 600 includes a volatile machine readable medium 607. The volatile machine readable medium 607 can be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system 600 also includes a bus 603 (e.g., PCI, ISA, PCI-Express, HyperTransport®, InfiniBand®, NuBus, etc.), a network interface 605 (e.g., an ATM interface, an Ethernet interface, a Frame Relay interface, SONET interface, wireless interface, etc.), and a nonvolatile machine-readable medium 609 (e.g., optical storage, magnetic storage, etc.). The network interfaces 605 can include the one or more interfaces that are to be configured (as described herein). The computer system 600 includes an interface configuration module 625 that can be representative of the interface configuration module 202 of FIG. 2 and can perform the operations for configuring interfaces (as described herein). Any one of these functionalities may be partially (or entirely) implemented in hardware and/or on the processing unit 601. For example, the functionality may be implemented with an application specific integrated circuit, in logic implemented in the processing unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601, the nonvolatile machine readable medium 609, the volatile machine-readable medium 607, the network interface 605, and the interface configuration module 625 are coupled to the bus 603. Although illustrated as being coupled to the bus 603, the volatile machine-readable medium 607 can be coupled to the processor unit 601.

While the embodiments are described with reference to various implementations and exploitations, it will be understood that these embodiments are illustrative and that the scope of the inventive subject matter is not limited to them. In general, techniques for configuration of interfaces communicatively coupled to link-local zones in a network as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method configuring of a node on a network comprising:
configuring an interface of the node on the network, wherein the configuring includes,
performing duplicate address detection for an address to be assigned to the interface as part of the configuring, wherein performing the duplicate address detection comprises,
transmitting, out from the interface onto the network, an address detection message having a destination address that is the same as the address to be assigned to the interface;
responsive to receiving the address detection message on a different interface of the node,
determining that the interface and the different interface are on a same link of the network; and
assigning the interface to be in a same link-local zone as the different interface.

2. The method of claim 1, wherein configuring the interface of the node on the network comprises,
responsive to not receiving the address detection message on a different interface of the node, assigning the interface to a unique link-local zone relative to any previously assigned link-local zones for previously configured interfaces of the node.

3. The method of claim 2, wherein in response to receiving the address detection message on a different interface of a different node, the different interface transmits a return message back to the interface.

4. The method of claim 3, wherein performing the duplicate address detection comprises assigning a different address to the interface of the node in response to receiving the return message at the interface.

5. The method of claim 4, wherein in response to not receiving a return message at the interface in response to the address detection message, assigning the address to the interface.

6. The method of claim 1, wherein the address detection message comprises a neighbor solicitation message.

7. The method of claim 1, wherein the network is based on a scoped address architecture.

8. A computer program product for configuring of a node on a network, the computer program product comprising:
a computer readable storage medium having computer usable program code embodied therewith, the computer usable program code comprising a computer usable program code configured to:
configure an interface of the node on the network, wherein configuration comprises,
perform duplicate address detection for an address to be assigned to the interface as part of the configuring, wherein the duplicate address detection comprises,
transmit, out from the interface onto the network, an address detection message having a destination address that is the same as the address to be assigned to the interface;
responsive to receipt of the address detection message on a different interface of the node,
determine that the interface and the different interface are on a same link of the network; and
assign the interface to be in a same link-local zone as the different interface.

9. The computer program product of claim 8, wherein configuration of the interface of the node on the network comprises,
responsive to no receipt of the address detection message on a different interface of the node, assign the interface to a unique link-local zone relative to any previously assigned link-local zones for previously configured interfaces of the node.

10. The computer program product of claim 9, wherein in response to receipt of the address detection message on a different interface of a different node, the different interface transmits a return message back to the interface.

11. The computer program product of claim 10, wherein the duplicate address detection comprises assign of a different address to the interface of the node in response to receipt of the return message at the interface.

12. The computer program product of claim 11, wherein in response to no receipt of a return message at the interface in response to the address detection message, the computer usable program code is configured to assign the address to the interface.

13. The computer program product of claim 8, wherein the address detection message comprises a neighbor solicitation message.

14. The computer program product of claim 8, wherein the network is based on a scoped address architecture.

15. An apparatus comprising:
a processor;
an interface configuration module executable on the processor, the interface configuration module configure to,
configure an interface of the node on the network, wherein configuration comprises,
perform duplicate address detection for an address to be assigned to the interface as part of the configuring, wherein the duplicate address detection comprises,
transmit, out from the interface onto the network, an address detection message having a destination address that is the same as the address to be assigned to the interface;
responsive to receipt of the address detection message on a different interface of the node,
determine that the interface and the different interface are on a same link of the network; and
assign the interface to be in a same link-local zone as the different interface.

16. The apparatus of claim 15, wherein configuration of the interface of the node on the network comprises,
responsive to no receipt of the address detection message on a different interface of the node, assign the interface to a unique link-local zone relative to any previously assigned link-local zones for previously configured interfaces of the node.

17. The apparatus of claim 16, wherein in response to receipt of the address detection message on a different interface of a different node, the different interface transmits a return message back to the interface.

18. The apparatus of claim 17, wherein the duplicate address detection comprises assign of a different address to the interface of the node in response to receipt of the return message at the interface.

19. The apparatus of claim 18, wherein in response to no receipt of a return message at the interface in response to the address detection message, the computer usable program code is configured to assign the address to the interface.

20. The apparatus of claim 15, wherein the network is based on a scoped address architecture.
